(19) United States
(12) Patent Application Publication
(10) Pub. No.: US 2026/0301200 A1
(43) Pub. Date: Oct. 1, 2026

(54) SINGLE-CAMERA COMPUTER VISION SYSTEM FOR THREE-DIMENSIONAL BIOMECHANICAL MOTION RECONSTRUCTION

(71) Applicant: Nuriva Tech A.I., Inc., Fort Lauderdale, FL (US)

(72) Inventors: Joseph Caruso, Fort Lauderdale, FL (US); Eliseo Robles, Fort Lauderdale, FL (US)

(73) Assignee: Nuriva Tech A.I., Inc., Fort Lauderdale, FL (US)

(21) Appl. No.: 19/630,154

(22) Filed: Mar. 26, 2026

Related U.S. Application Data
(60) Provisional application No. 63/779,014, filed on Mar. 27, 2025.

(51) Int. Cl. G06T 7/246; G06T 13/40; G06T 17/20

(52) U.S. Cl. CPC G06T 7/251; G06T 13/40; G06T 17/20; G06T 2207/10016; G06T 2207/30196

(57) ABSTRACT

A method for reconstructing three-dimensional biomechanical motion from monocular video includes receiving, by a processor, a sequence of two-dimensional frames captured by a single camera. The method includes performing, by the processor, two-dimensional analysis of each frame of the sequence to determine a motion intensity score and an event confidence score. The method includes detecting, by the processor, an event indicating significant motion based on the motion intensity score and the event confidence score. In response to detecting the event, the method includes activating, by the processor, three-dimensional reconstruction processing comprising identifying anatomical keypoints representing joints and body landmarks of a human subject in each frame and converting the identified anatomical keypoints into a three-dimensional human body model based on a parametric body model. The method includes generating biomechanical metrics from the three-dimensional human body model.

### CROSS-REFERENCE TO RELATED APPLICATIONS

This application claims the benefit of priority of U.S. Provisional Patent Application No. 63/779,014 filed Mar. 27, 2025, which is incorporated herein by reference in its entirety.

### TECHNICAL FIELD

The present disclosure relates to computer vision systems and methods for motion analysis.

### BACKGROUND

Traditional approaches to capturing human motion for biomechanical analysis typically involve specialized equipment such as multi-camera marker-based systems, markerless multi-camera systems, inertial measurement unit (IMU) systems, wearable sensor systems, single-camera two-dimensional pose estimation, and depth camera systems. Multi-camera marker-based systems represent a gold standard but are expensive and limited to laboratory settings. Markerless multi-camera systems still require multiple calibrated cameras. IMU systems suffer from drift errors over time. Single-camera two-dimensional pose estimation is limited to two-dimensional analysis. Depth camera systems have limited range and struggle in outdoor environments. These limitations create a technological gap for applications that would benefit from both the convenience of single-camera capture and the analytical depth of three-dimensional reconstruction.

There is a general desire for systems and methods that can provide three-dimensional biomechanical motion analysis using more accessible hardware configurations while maintaining accuracy in diverse real-world environments. Such systems would benefit applications in sports performance analysis, athletic training, physical therapy, rehabilitation, movement science research, and other domains where understanding human motion is valuable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some embodiments, a method for reconstructing three-dimensional biomechanical motion from monocular video includes receiving, by a processor, a sequence of two-dimensional frames captured by a single camera; performing, by the processor, two-dimensional analysis of each frame of the sequence to determine a motion intensity score and an event confidence score; detecting, by the processor, an event indicating significant motion based on the motion intensity score and the event confidence score; in response to detecting the event, activating, by the processor, three-dimensional reconstruction processing including: identifying anatomical keypoints representing joints and body landmarks of a human subject in each frame; and converting the identified anatomical keypoints into a three-dimensional human body model based on a parametric body model; and generating biomechanical metrics from the three-dimensional human body model.

In some embodiments, the method further includes temporally refining, by the processor, pose parameters of the parametric body model across multiple frames; and transforming, by the processor, the three-dimensional human body model into a normalized reference frame for biomechanical analysis, wherein transforming includes at least one of scale correction, orientation normalization, or ground-plane normalization.

In some embodiments, the method further includes detecting a human subject within each frame using an object detection model.

In some embodiments, identifying anatomical keypoints includes using a vision transformer model, and where the anatomical keypoints include major joints.

In some embodiments, the parametric body model includes a deformable mesh controlled by pose parameters defining joint rotations along a kinematic chain and shape parameters defining body proportions.

In some embodiments, the method further includes generating a skeletal representation from the three-dimensional human body model, wherein the skeletal representation includes a plurality of joints connected by rigid segments representing primary articulation points of the human body.

In some embodiments, the method further includes maintaining tracking continuity of the human subject during partial or complete occlusions using an occlusion handling process including predictive trajectory estimation, appearance modeling, and multi-hypothesis tracking.

In some embodiments, the multi-hypothesis tracking includes maintaining parallel pose hypotheses including a plurality of candidates with probability scoring based on biomechanical plausibility.

In some embodiments, the method further includes applying biomechanical constraints including joint angle limits and balance and support constraints during the occlusion handling process.

In some embodiments, the method further includes performing temporal optimization of pose parameters across a plurality of frames simultaneously using motion continuity priors that enforce realistic motion continuity.

In some embodiments, a system for reconstructing three-dimensional biomechanical motion from monocular video includes a memory storing instructions; and a processor coupled to the memory and configured to execute the instructions to: receive a sequence of two-dimensional frames captured by a single camera; perform two-dimensional analysis of each frame of the sequence to determine a motion intensity score and an event confidence score; detect an event indicating significant motion based on the motion intensity score and the event confidence score; in response to detecting the event, activate three-dimensional reconstruction processing including: identifying anatomical keypoints representing joints and body landmarks of a human subject in each frame; and converting the identified anatomical keypoints into a three-dimensional human body model based on a parametric body model; and generate biomechanical metrics from the three-dimensional human body model.

In some embodiments, the processor is further configured to: temporally refine pose parameters of the parametric body model across multiple frames; and transform the three-dimensional human body model into a normalized reference frame for biomechanical analysis, wherein transforming includes at least one of scale correction, orientation normalization, or ground-plane normalization.

In some embodiments, the processor is further configured to detect a human subject within each frame using an object detection model.

In some embodiments, identifying anatomical keypoints includes using a vision transformer model, and where the anatomical keypoints include major joints.

In some embodiments, the parametric body model includes a deformable mesh controlled by pose parameters defining joint rotations along a kinematic chain and shape parameters defining body proportions.

In some embodiments, the processor is further configured to generate a skeletal representation from the three-dimensional human body model, wherein the skeletal representation includes a plurality of joints connected by rigid segments representing primary articulation points of the human body.

In some embodiments, the processor is further configured to maintain tracking continuity of the human subject during partial or complete occlusions using an occlusion handling process including predictive trajectory estimation, appearance modeling, and multi-hypothesis tracking.

In some embodiments, the multi-hypothesis tracking includes maintaining parallel pose hypotheses including a plurality of candidates with probability scoring based on biomechanical plausibility.

In some embodiments, the processor is further configured to apply biomechanical constraints including joint angle limits and balance and support constraints during the occlusion handling process.

In some embodiments, the processor is further configured to perform temporal optimization of pose parameters across a plurality of frames simultaneously using motion continuity priors that enforce realistic motion continuity.

The foregoing general description of the illustrative embodiments and the following detailed description thereof are merely exemplary aspects of the teachings of this disclosure and are not restrictive.

### BRIEF DESCRIPTION OF FIGURES

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 illustrates a flowchart of a method for hybrid analysis with selective three-dimensional reconstruction from monocular video, according to aspects of the present disclosure.

FIG. 2 illustrates an example resource-adaptive embodiment in which lower-cost analysis identifies candidate intervals for higher-cost reconstruction processing, according to aspects of the present disclosure.

FIG. 3 illustrates an example process for kinematic fitting and output generation, according to aspects of the present disclosure.

FIG. 4 illustrates a flowchart of a method for handling occlusions during biomechanical motion tracking, according to aspects of the present disclosure.

FIG. 5 illustrates an example process for temporal refinement and normalization of a parametric articulated body model, according to aspects of the present disclosure.

FIG. 6 illustrates a system diagram showing technology modules supporting three-dimensional motion reconstruction, according to aspects of the present disclosure.

FIG. 7 illustrates a block diagram of a computing device, according to aspects of the present disclosure.

FIG. 8 illustrates a system diagram of a networked system for distributed biomechanical motion processing and analysis, according to aspects of the present disclosure.

### DETAILED DESCRIPTION

This disclosure is not limited to the particular systems, devices and methods described, as these may vary. The terminology used in the description is for the purpose of describing the particular versions or embodiments only and is not intended to limit the scope.

The present disclosure relates to systems and methods for reconstructing three-dimensional biomechanical motion from monocular video input. A single-camera approach may provide several advantages over traditional multi-camera marker-based systems and other specialized motion capture equipment. Hardware accessibility may be improved because the systems and methods described herein may eliminate the need for specialized and expensive motion capture equipment, instead utilizing video captured by a single camera. Environmental flexibility may be enhanced because the systems and methods may be employed in diverse real-world environments rather than controlled laboratory settings. Setup simplicity may be achieved because the systems and methods may require a standard camera rather than complex calibrated multi-camera systems. Subject comfort may be improved because the systems and methods may eliminate the need for marker attachment that can alter natural movement patterns. The systems and methods may include a processing pipeline comprising input acquisition, two-dimensional pose estimation, camera trajectory reconstruction, and three-dimensional human model reconstruction.

The systems and methods described herein may be applied across multiple domains. In some cases, the systems and methods may be used for sports performance analysis, including technical skill assessment, comparative analysis, competition analysis, talent identification, and injury risk screening. Sports performance analysis may enable athletes, coaches, and medical professionals to obtain actionable insights into movement patterns, performance metrics, and potential injury risks.

In some cases, the systems and methods may be used for athletic training and coaching applications. Athletic training and coaching applications may include remote coaching where coaches analyze athlete movement from a distance, self-directed learning where athletes review and improve their own technique, automated feedback systems that provide real-time or post-session guidance, progression tracking that monitors skill development over time, and group training optimization that enables analysis of multiple athletes during team training sessions. The systems and methods may enable coaches and athletes to obtain detailed biomechanical feedback without requiring in-person observation or specialized laboratory facilities.

In some cases, the systems and methods may be used for physical therapy and rehabilitation applications. Physical therapy and rehabilitation applications may include movement assessment, recovery tracking, home exercise monitoring, return-to-sport testing, and compensatory pattern identification. The systems and methods may enable clinicians to assess patient movement and track recovery progress without requiring patients to visit specialized laboratory facilities.

In some cases, the systems and methods may be used for movement science research applications. Movement science research applications may include field-based biomechanical studies conducted outside laboratory environments, longitudinal analysis tracking movement patterns over extended time periods, large-scale population studies analyzing movement characteristics across diverse subject groups, and movement database development for building repositories of annotated motion data. The systems and methods may enable researchers to collect biomechanical data in naturalistic settings without the constraints of traditional laboratory-based motion capture systems.

In some cases, the systems and methods may be used for industrial and occupational applications. Industrial and occupational applications may include ergonomic assessment, job-specific training, and functional capacity evaluation. The systems and methods may enable assessment of worker movements to identify potential ergonomic issues and optimize workplace safety.

In some cases, the systems and methods may be used for performance arts and animation applications. Performance arts and animation applications may include dance analysis, actor movement coaching, animation reference, and virtual performance capture. The systems and methods may enable artists and animators to capture and analyze movement for creative applications.

In some cases, the systems and methods may be used for educational applications. Educational applications may include movement science education where students learn biomechanical principles through interactive visualization, coach education programs that train coaches to analyze and improve athlete technique, self-directed learning resources that enable individuals to study movement patterns independently, and biomechanics visualization tools that illustrate complex movement concepts through three-dimensional representations. The systems and methods may provide accessible educational tools for teaching biomechanical analysis without requiring expensive laboratory equipment.

In some cases, the systems and methods may be used for consumer fitness and wellness applications. Consumer fitness and wellness applications may include home fitness guidance where individuals receive feedback on exercise form and technique, personalized training programs that adapt to individual movement patterns and capabilities, and virtual personal training that provides coaching and feedback through video analysis. The systems and methods may enable consumers to access biomechanical analysis capabilities previously available only in professional or clinical settings.

In some cases, the systems and methods may be used to analyze non-human subjects in addition to human subjects. Video analysis of non-human subjects may be performed using the systems and methods described herein, extending the applicability of the technology beyond human biomechanical analysis.

The systems and methods described herein address several problems associated with three-dimensional biomechanical motion analysis. A first problem includes the computational expense of continuous three-dimensional reconstruction processing for video analysis. The presented hybrid analysis approach with selective three-dimensional reconstruction may address this problem by performing lightweight two-dimensional analysis continuously while activating computationally intensive three-dimensional reconstruction only during motion segments that meet specified criteria, thereby reducing overall computational resource consumption without sacrificing analysis quality during significant motion events.

A second problem includes maintaining accurate tracking of human subjects during partial or complete occlusions that commonly occur in real-world environments. The multi-stage occlusion handling process may address this problem through the combination of predictive trajectory estimation, appearance modeling, and multi-hypothesis tracking with biomechanical constraints, enabling continuous tracking with seamless identity preservation and smooth trajectory recovery through occlusion periods.

A third problem includes the inherent depth ambiguity when reconstructing three-dimensional motion from monocular two-dimensional video input. The systems and methods may address this problem through the combination of parametric body models that encode anatomical constraints, physics-aware loss functions that enforce biomechanical plausibility, and temporal optimization that leverages motion continuity priors across multiple frames. These components work together to resolve depth ambiguities by constraining the solution space to reconstructions that are consistent with known properties of human body structure and movement.

A fourth problem includes the need for specialized and expensive motion capture equipment in traditional approaches to three-dimensional biomechanical analysis. The single-camera approach described herein may address this problem by enabling three-dimensional reconstruction from standard video input without requiring multi-camera systems, depth sensors, or marker-based tracking equipment, thereby improving accessibility and enabling deployment in diverse real-world environments.

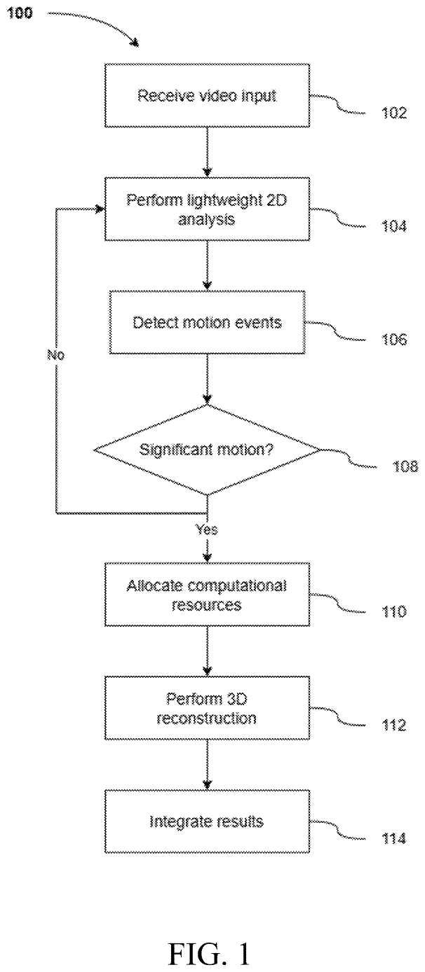

Referring to FIG. 1, a method 100 for hybrid analysis with selective 3D reconstruction from monocular video is illustrated. Method 100 may be performed by a processor coupled to a memory storing instructions, where the processor may be configured to execute the instructions to perform the steps of method 100. Method 100 may enable reconstruction of three-dimensional biomechanical motion from monocular video by strategically allocating computational resources, performing lightweight two-dimensional analysis continuously while activating computationally intensive three-dimensional reconstruction during motion segments that meet specified criteria.

Method 100 may include a step 102 of receiving video input. In step 102, a processor may receive a sequence of two-dimensional frames captured by a single camera. The frames may include various frame types including, for example, RGB frames, or other image formats suitable for video analysis. In some embodiments, the sequence of two-dimensional frames may be captured across a range of frame rates (e.g., from 24 to 60 frames per second) depending on the video source. Frame extraction may be performed using video processing libraries. In some cases, FFmpeg libraries supporting various video codecs may be used for frame extraction. In other cases, frame extraction may be performed by other tools including but not limited to OpenCV libraries, GStreamer multimedia framework, or DirectShow on Windows platforms. The two-dimensional frames may undergo preprocessing operations prior to subsequent analysis steps.

In some embodiments, the processor may also receive subject metadata associated with the video. Subject metadata may include height, weight, handedness, sport or activity classification, or identifiers that can be used for session management or later comparison. Receipt of such metadata is optional and is not required in all embodiments. The subject metadata may be used for scaling the kinematic skeletal model or for selecting sport-specific algorithm configurations. In some cases, on-device preprocessing may be performed using machine learning frameworks such as CoreML or TensorFlow.

The sequence of two-dimensional frames received in step 102 may undergo pixel-level analysis prior to feature extraction. Pixel-level analysis may include color normalization where each pixel undergoes normalization to account for variations in lighting conditions and camera characteristics. The color-normalized pixels may be processed through convolutional layers for feature extraction, generating feature maps that capture local patterns and structures within each frame. The convolutional layers may extract hierarchical features at multiple levels of abstraction, from low-level edge and texture features to higher-level semantic features representing body parts and pose configurations.

Following feature extraction, the processor may perform temporal correlation where extracted features are analyzed across consecutive frames to establish temporal continuity. The temporal correlation may enable tracking of motion patterns and maintain consistency between frames by identifying corresponding features across the temporal sequence. The temporal correlation may provide input for subsequent motion analysis operations by establishing frame-to-frame correspondences that support accurate motion estimation and tracking.

With continued reference to FIG. 1, method 100 may include a step 104 of performing lightweight 2D analysis. In step 104, the processor may perform two-dimensional analysis of each frame of the sequence to determine a motion intensity score and an event confidence score. The two-dimensional analysis may use a lightweight neural network architecture to minimize computational overhead during continuous processing. The lightweight neural network may serve as an efficient feature extraction and motion classification network that enables continuous frame-by-frame analysis with minimal computational overhead The lightweight network may calculate frame differences and perform binary classification of motion significance to generate the motion intensity score and the event confidence score for each frame.

In some cases, the lightweight neural network may include a MobileNetV3, MobileNetV2, EfficientNet-Lite, ShuffleNet, or SqueezeNet. By way of non-limiting example, the network may have approximately 1.5 million parameters used for the lightweight two-dimensional analysis.

Method 100 may include a step 106 of detecting motion events. In step 106, the processor may analyze the motion intensity score and the event confidence score to detect an event indicating significant motion. Event detection may use a temporal convolutional network architecture with dilated convolutional blocks. In some cases, the temporal convolutional network may include 4 dilated convolutional blocks. The event detection may further use a multi-head attention layer to capture temporal dependencies across frames. In some cases, the multi-head attention layer may include 16 attention heads and 512 dimensions. The temporal convolutional network and multi-head attention layer may perform sport-specific event classification and calculate confidence scores for detected events.

In some cases, the object detection models may include YOLOv8, YOLOv9, YOLOv10, RT-DETR, or CenterNet. In some cases, the backbone network may comprise a cross-stage partial network architecture such as CSPDarknet53. Other example backbone architectures that may be used include ResNet, EfficientNet, ConvNeXt, or Swin Transformer backbones.

As further shown in FIG. 1, method 100 may include a step 108 of determining whether significant motion is detected. In step 108, the processor may compare the motion intensity score and the event confidence score against threshold values to determine whether the detected event indicates significant motion. Temporal proximity to detected events may also be considered when determining whether significant motion is detected. If significant motion is not detected at step 108, method 100 may continue step 104 of lightweight two-dimensional analysis.

If significant motion is detected at step 108, method 100 may proceed to a step 110 of allocating computational resources. In step 110, the processor may allocate computational resources for three-dimensional reconstruction processing. Resource management may include memory allocation based on frame requirements for the three-dimensional reconstruction. Resource management may further include Graphical Processing Unit (GPU) scheduling with batch processing to optimize parallel computation. Resource management may also include input/output optimization for frame access to reduce latency during intensive processing operations.

Method 100 may include a step 112 of performing 3D reconstruction. In step 112, the processor may activate three-dimensional reconstruction processing in response to detecting the event indicating significant motion. The three-dimensional reconstruction processing may convert the two-dimensional frame data into a three-dimensional human body model, as described in further detail below with respect to subsequent figures.

Method 100 may include a step 114 of integrating results. In step 114, the processor may generate biomechanical metrics from the three-dimensional human body model. The biomechanical metrics may include joint angle calculations, velocity extraction, and other movement parameters. Results integration may further include data fusion with the two-dimensional analysis results from step 104 and generation of standardized output formats for interfacing with external analysis platforms. In some cases, the output may include synchronized visualizations comprising overlays on source video or interactive renderings of a reconstructed body representation. The synchronized visualizations may include skeletal overlays, mesh overlays, wireframe representations, or combinations thereof derived from the parametric articulated body model. The outputs may be used for review workflows, coaching workflows, training workflows, rehabilitation workflows, comparison across sessions, or combinations thereof. Following step 114, method 100 may return to step 104 to continue lightweight two-dimensional analysis for subsequent frames.

The sequence of two-dimensional frames received in step 102 may undergo preprocessing prior to the lightweight two-dimensional analysis of step 104. Preprocessing the sequence may use multi-scale Gaussian pyramidal processing to enable robust feature detection across different scales. The multi-scale Gaussian pyramidal processing may create a resolution pyramid where each frame is represented at multiple resolutions. In some cases, the resolution pyramid may include multiple scales with a downsampling factor, such that each successive level of the pyramid represents the frame at a reduced resolution compared to the previous level. The multi-scale representation may enable detection of features that appear at different sizes within the frame depending on subject distance from the camera and subject size.

Each level of the resolution pyramid may be processed with Gaussian filters to remove noise while preserving structural information. The Gaussian filters may use a sigma value that balances noise reduction with preservation of edge and structural details. The Gaussian filtering at each scale of the pyramid may reduce high-frequency noise components that could otherwise interfere with subsequent feature detection and pose estimation operations.

In some cases, alternatives to multi-scale Gaussian pyramidal processing may be used for preprocessing the sequence of two-dimensional frames. Alternatives may include Laplacian pyramidal processing, wavelet-based multi-resolution analysis, scale-space representation, feature pyramid networks, image pyramids with bilinear or bicubic interpolation, and steerable pyramids. The selection of preprocessing approach may depend on the specific application requirements, computational constraints, and the characteristics of the video input being analyzed.

Following preprocessing, the processor may detect a subject within each frame using an object detection model. The object detection model may identify and localize human subjects within each frame by generating bounding boxes around detected persons. In some cases, detecting a human subject may use an ensemble of object detection models to provide robust detection across varying conditions. The ensemble approach may combine outputs from multiple models to improve detection reliability. In alternative embodiments, the processor may be configured to detect non-human subjects.

In some cases, the ensemble may comprise real-time single-stage detection architectures that process entire frames in a single forward pass to achieve efficient detection. A primary model may provide general human detection with bounding boxes, while specialized variants within the ensemble may offer additional information for challenging detection scenarios. The object detection models may use convolutional neural network architectures with backbone networks designed for efficient feature extraction. In some cases, the backbone network may comprise a cross-stage partial network architecture. Cross-stage partial network architectures may provide a balance between detection accuracy and computational efficiency through cross-stage partial connections that reduce computational redundancy while maintaining gradient flow during training.

In some cases, alternatives to real-time single-stage detection architectures may be used for object detection. The selection of object detection model may depend on the specific application requirements, including detection accuracy, processing speed, and computational resource availability.

The object detection models may operate at processing speeds suitable for video analysis applications The processing time may vary based on frame resolution, the number of subjects present in the frame, and the specific GPU hardware configuration. The bounding boxes generated by the object detection model may define regions of interest within each frame for subsequent anatomical keypoint identification operations.

The three-dimensional reconstruction processing activated in response to detecting significant motion may include identifying anatomical keypoints representing joints and body landmarks of a human subject in each frame. Identifying anatomical keypoints may use a vision transformer model that applies self-attention mechanisms to accurately locate body landmarks even in challenging poses or partial occlusions. In some cases, identifying anatomical keypoints may use a modified Vision Transformer model. The vision transformer model may include multiple attention heads and transformer layers to capture spatial relationships between different body regions.

The anatomical keypoints may include major joints and body landmarks that define the skeletal structure of the human subject. The anatomical keypoints may follow a standardized format to enable compatibility with existing pose estimation frameworks and datasets. In some cases, the vision transformer model may identify a set of anatomical keypoints corresponding to major human joints and body landmarks. The keypoints locations may correspond to anatomical landmarks including nose, eyes, ears, shoulders, elbows, wrists, hips, knees, ankles, or other landmarks. The identified anatomical keypoints may provide two-dimensional coordinates within each frame that serve as input for subsequent three-dimensional reconstruction operations.

By way of non-limiting example, the vision transformer model may include a ViTPose-L model, HRNet, HigherHRNet, AlphaPose, MediaPipe Pose, or RTMPose. In some cases, the anatomical keypoints may follow the COCO (Common Objects in Context) keypoint standard, the MPII Human Pose standard, the Human3.6M standard, or the HALPE keypoint format. In some cases, the vision transformer model may include 16 attention heads and 24 transformer layers.

Following identification of the anatomical keypoints, the processor may convert the identified anatomical keypoints into a three-dimensional human body model based on a parametric body model. The parametric body model may represent the human body using a parameterized mesh that can be adjusted to match different body shapes and poses. The mesh vertices may be controlled by pose parameters representing joint angles and shape parameters representing body proportions and dimensions. The pose parameters may define the rotational configuration of each joint in the kinematic chain, while the shape parameters may define variations in body size, limb length, and overall body proportions.

In some cases, the parametric body model may include a Skinned Multi-Person Linear (SMPL) model. The SMPL model may represent the human body as a mesh with a plurality of vertices that define the body surface geometry. In some cases, the SMPL model may represent the human body as a mesh with a plurality of vertices (e.g., 10,475 or more to include hand and face articulation). In other cases, the parametric body model may include SMPL-X, which extends SMPL to include expressive hands and face modeling. In some cases, the parametric body model may include STAR (Sparse Trained Articulated Human Body Regressor), GHUM (Generative 3D Human Shape and Articulated Pose Models), SCAPE (Shape Completion and Animation of People), or MANO for hand-specific modeling. Other parametric body models that may be used include FLAME for head and face modeling, SUPR (Sparse Unified Part-Based Human Representation), or neural implicit body representations such as NASA (Neural Articulated Shape Approximation) or SNARF (Structured Neural Articulated Radiance Fields).

The processor may generate a wire frame model from the three-dimensional human body model. The wire frame model may provide a simplified skeletal representation extracted from the full parametric body model for visualization and analysis purposes. The wire frame model may include a plurality of joints connected by rigid segments representing primary articulation points of the human body. In some cases, the wire frame model may include a plurality of joints (e.g., 24 or more) connected by rigid segments. The joints of the wire frame model may correspond to anatomical articulation points including the spine, neck, head, shoulders, elbows, wrists, hips, knees, and ankles. The wire frame model may be overlaid on the original video to provide visual feedback and may serve as the foundation for subsequent biomechanical analysis operations.

The three-dimensional reconstruction processing may include a reconstruction optimization procedure that refines the pose and shape parameters of the parametric body model. The reconstruction optimization may use an iterative process that minimizes a multi-term loss function to achieve accurate alignment between the reconstructed three-dimensional model and the observed two-dimensional keypoints. The multi-term loss function may combine reprojection error, prior terms for realistic pose and shape distributions, temporal smoothness, and physics-based constraints.

The reprojection error term may measure the difference between the projected locations of the three-dimensional model joints and the detected two-dimensional keypoints in each frame. Minimizing the reprojection error may encourage the three-dimensional reconstruction to produce joint positions that, when projected back to two dimensions using the estimated camera parameters, align with the observed keypoint detections.

The prior terms for realistic pose and shape distributions may penalize pose and shape parameter values that deviate from statistically observed human body configurations. The prior terms may be derived from datasets of human body scans and motion capture data that define the range of plausible body shapes and joint angle configurations. The prior terms may prevent the optimization from converging to anatomically implausible solutions that might otherwise minimize the reprojection error.

The temporal smoothness term may encourage consistency in pose and shape parameters across consecutive frames. The temporal smoothness term may penalize abrupt changes in joint angles and body shape that would indicate physically unrealistic motion discontinuities. The temporal smoothness term may improve reconstruction stability by leveraging the assumption that human motion exhibits continuous trajectories over time.

The physics-based constraints may enforce biomechanically plausible motion during the reconstruction optimization. The physics-based constraints may include joint angle limit constraints that prevent joints from exceeding their anatomical range of motion. The physics-based constraints may further include momentum conservation terms that encourage physically realistic acceleration patterns. The physics-based constraints may also include balance and support constraints that penalize reconstructions where the body center of mass is not appropriately supported by ground contact points. The combination of these constraint terms within the multi-term loss function may guide the optimization toward reconstructions that are both consistent with the observed image evidence and physically plausible.

The four components of the multi-term loss function may work together during reconstruction optimization. Each term may contribute differently to the optimization objective. The reprojection error term may ensure fidelity to observations by measuring how well the reconstruction matches the detected keypoints in the video. The prior terms for realistic pose and shape distributions may ensure statistical plausibility by constraining the solution to anatomically normal configurations, which may be particularly important for resolving depth ambiguity inherent in monocular video where multiple 3D configurations could produce the same 2D projection. The temporal smoothness term may ensure continuity over time by leveraging the physical principle that human motion follows continuous trajectories. The physics-based constraints may ensure biomechanical validity by enforcing what is physically possible given anatomical joint limits, momentum conservation, and balance requirements. The combination of these terms may guide the optimization toward reconstructions that satisfy all constraints simultaneously, narrowing the solution space to configurations that are consistent with the observed evidence while remaining anatomically plausible, temporally smooth, and physically realistic.

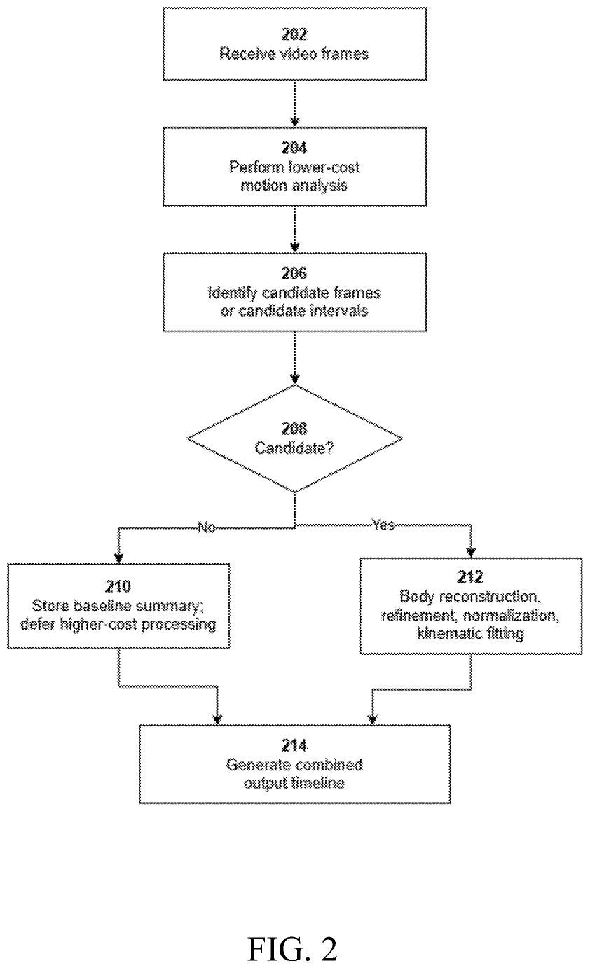

Referring to FIG. 2, an example resource-adaptive embodiment is illustrated in which lower-cost analysis identifies candidate intervals for higher-cost reconstruction processing. The resource-adaptive embodiment may enable efficient allocation of computational resources by performing lightweight analysis continuously and reserving computationally intensive processing for video segments that warrant detailed reconstruction.

At step 202, video frames may be received by the system. The video frames may comprise the sequence of two-dimensional frames captured by a single camera as described with respect to step 102 of method 100. The received frames may be queued for processing through the resource-adaptive pipeline.

At step 204, the system may perform lower-cost motion analysis on the received frames. The lower-cost motion analysis may correspond to the lightweight two-dimensional analysis described with respect to step 104 of method 100. The lower-cost motion analysis may use computationally efficient algorithms to assess motion characteristics without performing full three-dimensional reconstruction. The lower-cost motion analysis may generate motion intensity scores and event confidence scores that characterize the motion content of each frame.

At step 206, the system may identify candidate frames or candidate intervals based on the lower-cost motion analysis results. The identification may use the motion intensity scores and event confidence scores to determine which portions of the video sequence contain motion of sufficient significance to warrant higher-cost processing. The candidate intervals may correspond to periods containing detected events or motion patterns that exceed threshold criteria.

At step 208, the system may determine whether the current frame or interval qualifies as a candidate for higher-cost processing. The determination may compare the motion analysis results against threshold values to classify each frame or interval as either a candidate for detailed reconstruction or a non-candidate suitable for baseline processing only.

If the determination at step 208 is negative, the process may proceed to step 210 where the system may store a baseline summary and defer higher-cost processing. The baseline summary may include the two-dimensional analysis results and motion characterization data without full three-dimensional reconstruction. Deferring higher-cost processing may conserve computational resources for video segments that do not contain significant motion events.

If the determination at step 208 is affirmative, the process may proceed to step 212 where the system may perform body reconstruction, refinement, normalization, and kinematic fitting operations. The body reconstruction may correspond to the three-dimensional reconstruction processing described with respect to step 112 of method 100. The refinement may include the reconstruction optimization procedure that minimizes the multi-term loss function. The normalization may include temporal refinement and reference-frame normalization operations. The kinematic fitting may derive biomechanical metrics from the reconstructed body model.

At step 214, the system may generate a combined output timeline that integrates results from both processing paths. The combined output timeline may include baseline summaries for non-candidate intervals and detailed biomechanical metrics for candidate intervals that received higher-cost processing. The combined output timeline may provide a comprehensive representation of the motion content across the entire video sequence while reflecting the differential processing applied to different segments based on their motion significance.

In some embodiments, the three-dimensional reconstruction processing may employ a multi-model fusion approach that combines outputs from two or more distinct neural network models. Image features extracted from video frames may be processed by a first neural network model that directly regresses three-dimensional body mesh vertices, producing a body representation that captures fine-grained surface geometry. A second neural network model, distinct from the first, may produce body pose parameters in a camera-space reference frame, providing scale-consistent pose information derived from temporal motion patterns.

The body reconstruction data may include anatomical keypoints, joint positions, body-surface geometry, pose coefficients, confidence values, or combinations thereof. The body-surface geometry may represent the three-dimensional surface shape of the human subject derived from the parametric body model mesh.

In some cases, the body reconstruction data may include confidence values associated with each detected keypoint or joint position. The confidence values may indicate the reliability of each detection and may be used for downstream filtering, weighting, or quality assessment of the reconstruction.

The outputs of the first and second models may be geometrically aligned using a rigid transformation (e.g., Procrustes analysis) which computes one or more of rotation, translation, and scale transformation that minimizes the positional error between corresponding points of the two representations. The geometric alignment may correct for differences in scale, orientation, and coordinate system conventions between the two model outputs, producing an aligned three-dimensional body reconstruction that combines the strengths of both models.

The first neural network model may comprise a graph convolutional network architecture that operates on the detected two-dimensional keypoints as graph nodes with edges representing anatomical connections between body parts. The graph convolutional network may propagate information across the body structure through message passing operations, enabling each joint to incorporate contextual information from neighboring joints when predicting its three-dimensional position. The first neural network model may include multiple graph convolutional layers followed by fully connected layers that regress the mesh vertex positions directly from the aggregated graph features. In some cases, the first neural network model may use attention mechanisms to weight the contributions of different body parts based on detection confidence and spatial relationships.

The second neural network model may comprise a temporal convolutional network architecture that processes sequences of two-dimensional pose detections across multiple frames to estimate body pose parameters. The temporal convolutional network may use dilated convolutions with increasing dilation rates to capture motion patterns across different temporal scales without requiring recurrent connections. The second neural network model may output pose parameters in a camera-centric coordinate system, where the root joint position and body orientation are defined relative to the camera viewpoint rather than a global reference frame. The camera-space representation may provide scale consistency by leveraging the temporal motion patterns to resolve depth ambiguity, as the apparent motion of body parts across frames provides cues about their relative distances from the camera.

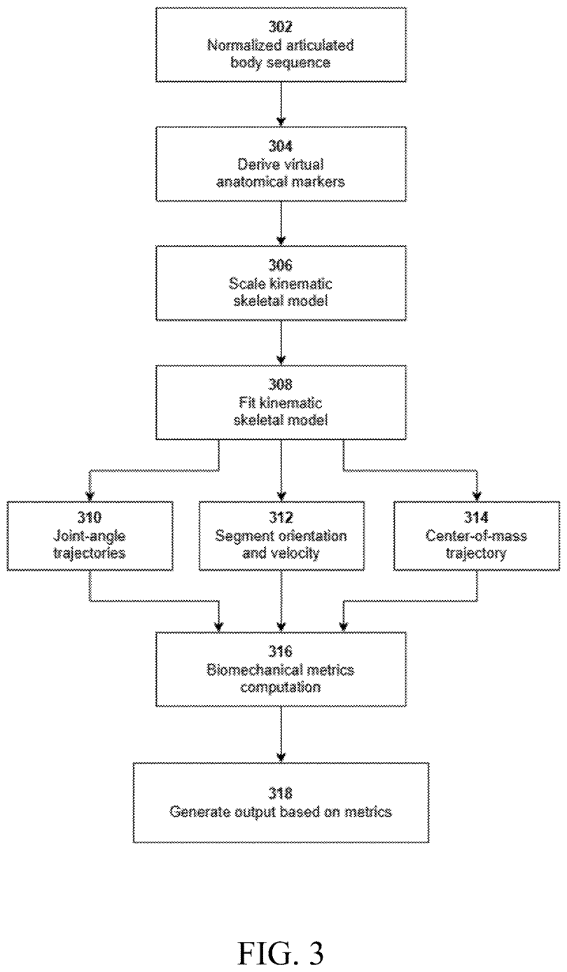

Referring to FIG. 3, an example process for kinematic fitting and output generation is illustrated. The kinematic fitting process may convert the normalized articulated body sequence into biomechanical metrics suitable for analysis and reporting.

At step 302, a normalized articulated body sequence may be received as input. The normalized articulated body sequence may comprise the temporally refined and reference-frame normalized three-dimensional human body model generated through the reconstruction and normalization operations described previously. The normalized sequence may provide a consistent representation of the subject's motion that has been corrected for scale, orientation, and ground-plane alignment.

At step 304, virtual anatomical markers may be derived from the normalized sequence. The virtual anatomical markers may correspond to specific locations on the body surface or skeletal structure that are relevant for biomechanical analysis. The virtual anatomical markers may be computed from the mesh vertices and joint positions of the parametric body model. The derived markers may include locations corresponding to traditional motion capture marker placements used in biomechanical research, enabling compatibility with established analysis methodologies.

In some cases, the virtual anatomical markers may be derived from the mesh vertices of the parametric body model using a learned joint regressor matrix that maps vertex positions to anatomical joint locations. These virtual marker trajectories may serve as input to an inverse kinematics solver that computes joint angle time series by fitting a musculoskeletal skeleton model to the marker trajectories.

By way of non-limiting example, the musculoskeletal skeleton model may comprise an OpenSim model. Other example musculoskeletal simulation platforms that may be used include AnyBody, Biomechanics of Bodies (BoB), or custom kinematic chain implementations.

At step 306, a kinematic skeletal model may be scaled. The scaling operation may adjust the dimensions of a standardized kinematic skeletal model to match the body proportions of the specific subject being analyzed. The scaling may use the shape parameters from the parametric body model or measurements derived from the virtual anatomical markers to determine appropriate segment lengths for the kinematic model.

At step 308, the kinematic skeletal model may be fitted to the derived virtual anatomical markers. The fitting operation may determine joint angles and segment orientations that position the kinematic skeletal model to match the virtual marker locations at each frame. The fitting may use inverse kinematics algorithms to solve for the joint angle configurations that minimize the distance between the kinematic model joints and the corresponding virtual markers.

The fitting process at step 308 may produce three parallel output categories. At step 310, joint-angle trajectories may be generated. The joint-angle trajectories may represent the time-varying angular configuration of each joint in the kinematic chain throughout the motion sequence. At step 312, segment orientation and velocity may be generated. The segment orientation and velocity may represent the spatial orientation and rotational velocity of each body segment over time. At step 314, center-of-mass trajectory may be generated. The center-of-mass trajectory may represent the position and velocity of the whole-body center of mass throughout the motion sequence.

At step 316, biomechanical metrics computation may be performed. The biomechanical metrics computation may combine the joint-angle trajectories, segment orientation and velocity, and center-of-mass trajectory to derive higher-level metrics relevant for the specific analysis application. The biomechanical metrics may include peak joint angles, angular velocities, joint powers, ground reaction force estimates, and other quantities used in biomechanical assessment.

At step 318, output may be generated based on the computed metrics. The output generation may format the biomechanical metrics for presentation, storage, or export to external analysis platforms. The output may include visualizations, numerical reports, and data files in standardized formats for integration with biomechanical analysis software.

In some cases, the output may include structured output data containing the biomechanical joint measurements, derived metrics, or both in association with frame timing from the sequence of image frames. The frame timing association may enable temporal alignment of the biomechanical data with the original video sequence for synchronized analysis and review.

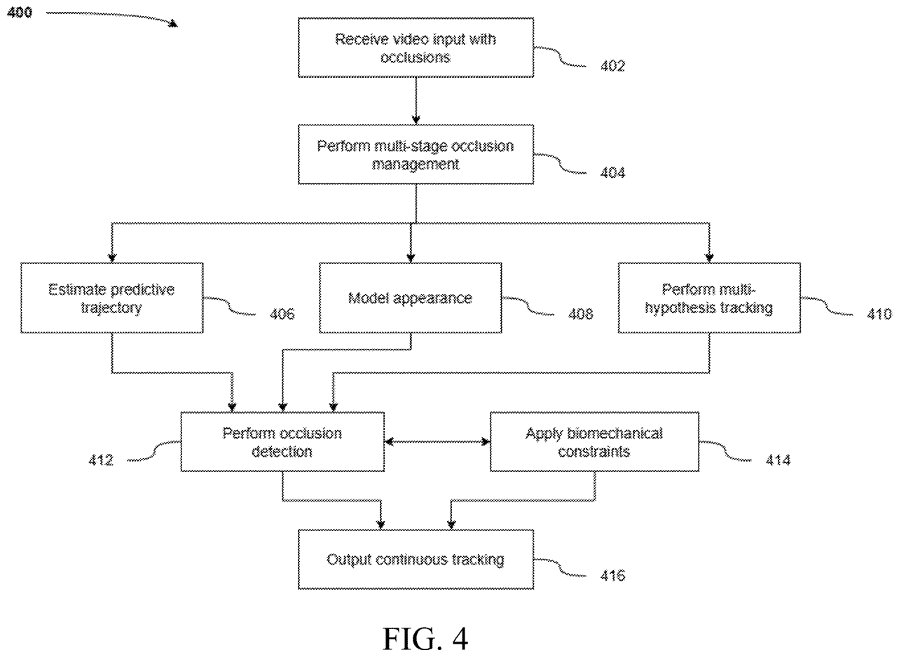

Referring to FIG. 4, a method 400 for handling occlusions during biomechanical motion tracking is illustrated. Method 400 may be performed by a processor coupled to a memory storing instructions, where the processor may be configured to execute the instructions to perform the steps of method 400. Method 400 may enable the processor to maintain tracking continuity of the human subject during partial or complete occlusions using an occlusion handling process including predictive trajectory estimation, appearance modeling, and multi-hypothesis tracking.

Method 400 may include a step 402 of receiving video input that contains occlusions where a human subject is partially or completely obscured. In step 402, the processor may receive frames from the sequence of two-dimensional frames where the human subject is occluded by other objects, other persons, or environmental elements. Partial occlusions may occur when a portion of the human subject's body is obscured while other portions remain visible. Complete occlusions may occur when the entire human subject is temporarily obscured from view. The occlusions may be common in real-world settings such as sporting environments where other players, equipment, or environmental features may obstruct the camera's view of the tracked subject.

With continued reference to FIG. 4, method 400 may include a step 404 of performing multi-stage occlusion management by branching into three parallel processing paths. In step 404, the processor may initiate three concurrent processing operations that each contribute to maintaining tracking continuity through the occlusion period. The three parallel processing paths may include predictive trajectory estimation, appearance modeling, and multi-hypothesis tracking. The parallel processing paths may operate simultaneously to generate complementary information that supports robust tracking through occlusions of varying duration and severity.

Method 400 may include a step 406 of estimating predictive trajectory. In step 406, the processor may perform predictive trajectory estimation using Kalman filtering with biomechanical motion models. The Kalman filtering may combine observed measurements with predictions from a motion model to estimate the current state of the human subject even when direct observations are unavailable due to occlusion. The biomechanical motion models may encode knowledge of human movement patterns to generate predictions that are consistent with anatomically plausible motion.

The predictive trajectory estimation may use joint angle velocity and acceleration constraints to bound the predicted motion within physically realistic limits. The joint angle velocity constraints may limit the rate at which joint angles can change between frames based on the maximum angular velocities achievable by human joints. The acceleration constraints may limit the rate of change of velocity to prevent predictions that would require physically impossible forces. The predictive trajectory estimation may further use sport-specific motion priors that encode typical movement patterns observed in particular sporting contexts. The sport-specific motion priors may improve prediction accuracy by biasing the trajectory estimates toward movements that are common in the relevant sporting domain.

As further shown in FIG. 4, method 400 may include a step 408 of modeling appearance. In step 408, the processor may perform appearance modeling by maintaining temporal feature aggregation with embeddings that capture the visual characteristics of the tracked human subject. In some cases, the appearance modeling may use multidimensional (e.g., 100+ dimensional) embeddings to represent the visual appearance of the subject. The embeddings may encode color, texture, and structural features that distinguish the tracked subject from other persons or objects in the scene.

The appearance modeling may use a multi-scale feature pyramid to capture appearance information at different spatial resolutions. In some cases, the multi-scale feature pyramid may include 5 scales. The multi-scale representation may enable robust appearance matching even when the subject's apparent size changes due to movement toward or away from the camera. The appearance modeling may further use weighted historical sampling to maintain a representation of the subject's appearance over time. The weighted historical sampling may assign higher weights to more recent observations while retaining information from earlier frames to handle temporary appearance changes due to pose variation or lighting conditions.

Method 400 may include a step 410 of performing multi-hypothesis tracking. In step 410, the processor may maintain parallel pose hypotheses including a plurality of candidates with probability scoring based on biomechanical plausibility. In some cases, the multi-hypothesis tracking may maintain multiple parallel pose hypothesis candidates. Each hypothesis may represent a different possible configuration of the human subject during the occlusion period. The probability scoring may evaluate each hypothesis based on consistency with the biomechanical motion models and the observed evidence before and after the occlusion.

The multi-hypothesis tracking may include forward-backward consistency verification to validate the hypotheses. The forward-backward consistency verification may propagate each hypothesis forward through the occlusion period and then backward from observations after the occlusion ends. Hypotheses that produce consistent trajectories in both directions may receive higher probability scores, while hypotheses that produce inconsistent trajectories may be discarded or assigned lower weights.

With continued reference to FIG. 4, the method 400 may include a step 412 that performs occlusion detection. Step 412 may be performed based on the outputs from steps 406 and 408. In step 412, the processor may detect occlusions using confidence thresholds and anatomical completeness analysis. The confidence thresholds may evaluate the reliability of keypoint detections, where low confidence values may indicate that the corresponding body part is occluded. The anatomical completeness analysis may assess whether the expected set of anatomical keypoints is detected, where missing keypoints may indicate partial occlusion of the corresponding body regions.

The occlusion detection may further use temporal consistency and geometric analysis. The temporal consistency analysis may compare the detected pose in the current frame with poses in preceding frames to identify sudden changes that may indicate occlusion onset. The geometric analysis may evaluate the spatial relationships between detected keypoints to identify configurations that are inconsistent with the expected body structure, which may indicate that some keypoints are incorrectly detected due to occlusion.

Method 400 may include a step 414 that applies biomechanical constraints. In step 414, the processor may apply biomechanical constraints including joint angle limits and balance and support constraints during the occlusion handling process. The joint angle limits may constrain the predicted joint configurations to remain within the anatomical range of motion for each joint. The balance and support constraints may ensure that the predicted body configurations maintain physically plausible relationships between the center of mass and the support points.

The biomechanical constraints may further include sport-specific pose priors that encode typical body configurations observed in particular sporting contexts. The sport-specific pose priors may bias the tracking toward poses that are common in the relevant sport, improving accuracy when the subject is performing sport-specific movements during the occlusion period.

Step 412 and step 414 may interact to refine tracking estimates. The occlusion detection results from step 412 may inform the application of biomechanical constraints in step 414 by indicating which body regions are occluded and require constraint-based estimation. The biomechanical constraint evaluation from step 414 may inform the occlusion detection in step 412 by identifying poses that violate biomechanical constraints and may therefore indicate detection errors due to occlusion. The bidirectional interaction may enable iterative refinement of the tracking estimates until convergence to a consistent solution.

Method 400 may include a step 416 that outputs continuous tracking with seamless identity preservation and smooth trajectory recovery through occlusions. In step 416, the processor may generate tracking output that maintains the identity of the tracked human subject throughout the occlusion period. The seamless identity preservation may ensure that the subject is correctly re-identified when the subject emerges from occlusion, avoiding identity switches with other persons in the scene. The smooth trajectory recovery may produce motion trajectories that transition smoothly from the pre-occlusion observations through the predicted occlusion period to the post-occlusion observations, avoiding discontinuities that would indicate tracking failures.

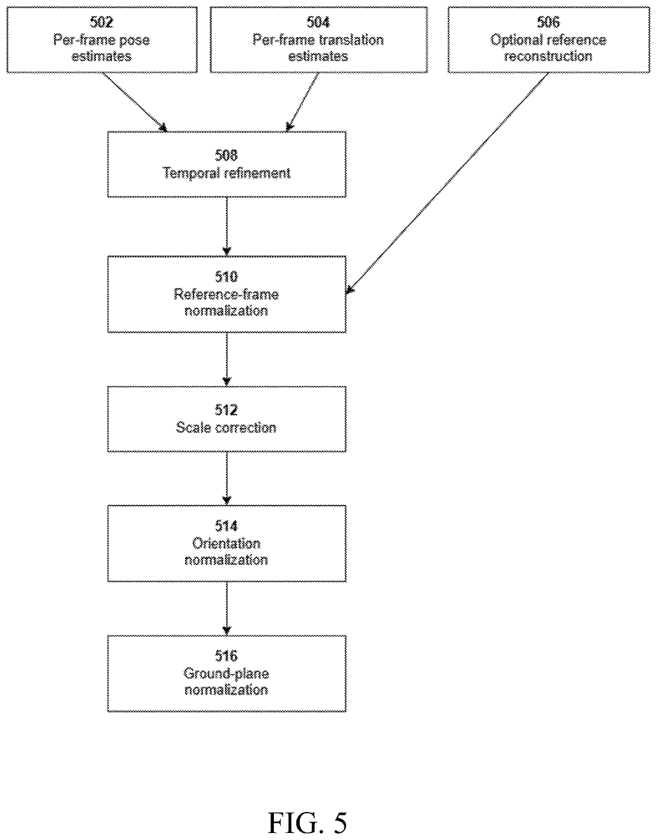

Referring to FIG. 5, an example process for temporal refinement and normalization of a parametric articulated body model is illustrated. The temporal refinement and normalization process may convert per-frame pose and translation estimates into a temporally consistent and spatially normalized representation suitable for biomechanical analysis.

At step 502, per-frame pose estimates may be received as input. The per-frame pose estimates may comprise the joint angle parameters of the parametric body model determined through the three-dimensional reconstruction processing for each frame of the video sequence. The per-frame pose estimates may contain noise and temporal inconsistencies due to independent processing of each frame.

At step 504, per-frame translation estimates may be received as input. The per-frame translation estimates may comprise the global position of the body model root joint in three-dimensional space for each frame. The per-frame translation estimates may define the trajectory of the human subject through the scene over the duration of the video sequence.

At step 506, an optional reference reconstruction may be received as input. The optional reference reconstruction may comprise a previously processed reconstruction of the same subject or a standardized reference pose that defines the desired coordinate system and scale for the output. The optional reference reconstruction may enable alignment of the current reconstruction with external reference data or with other reconstructions of the same subject for comparative analysis.

At step 508, temporal refinement across multiple frames may be performed. The temporal refinement may receive the per-frame pose estimates from step 502 and the per-frame translation estimates from step 504. The temporal refinement may apply smoothing and optimization operations across a window of multiple frames to reduce noise and enforce temporal consistency in the pose and translation parameters. The temporal refinement may use the motion continuity priors described previously to encourage smooth trajectories while preserving genuine motion dynamics.

The temporal refinement may apply different filtering parameters to different anatomical regions. Torso and core body parameters may be filtered at a first cutoff frequency. Extremity parameters including hands and fingers may be filtered at a second, different cutoff frequency to preserve rapid motion while removing noise. Global orientation and camera rotation parameters may be filtered at a third cutoff frequency to ensure smooth camera-space trajectories. In some cases, the temporal filtering may employ zero-phase filtering techniques such as Butterworth filters applied in both forward and reverse directions to avoid introducing phase distortion.

At step 510, reference-frame normalization may be performed. The reference-frame normalization may receive the temporally refined output from step 508 and the optional reference reconstruction from step 506. The reference-frame normalization may transform the reconstruction into a standardized coordinate system defined by the reference reconstruction or by default normalization conventions. The reference-frame normalization may enable consistent comparison of reconstructions across different video captures and different subjects.

At step 512, scale correction may be performed. The scale correction may adjust the dimensions of the reconstruction to match a known or estimated physical scale. The scale correction may use anthropometric measurements, reference objects of known size in the scene, or statistical body proportion models to determine the appropriate scale factor. The scale correction may ensure that the output reconstruction represents physically accurate dimensions for subsequent biomechanical analysis.

At step 514, orientation normalization may be performed. The orientation normalization may rotate the reconstruction to align with a standardized orientation convention. The orientation normalization may align the subject's facing direction, vertical axis, or other anatomical reference directions with predefined coordinate axes. The orientation normalization may facilitate comparison of movements across different camera viewpoints and subject orientations.

At step 516, ground-plane normalization may be performed. The ground-plane normalization may adjust the vertical position and orientation of the reconstruction to align with an estimated or known ground plane. The ground-plane normalization may ensure that the subject's feet contact the ground plane appropriately during stance phases and that the vertical coordinate accurately represents height above the ground surface. The ground-plane normalization may be important for biomechanical analyses that depend on accurate representation of ground contact and vertical displacement.

The ground-plane normalization may estimate a ground plane from the three-dimensional body reconstruction based on foot contact positions. The reconstruction may be normalized to a canonical coordinate system defined relative to the estimated ground plane.

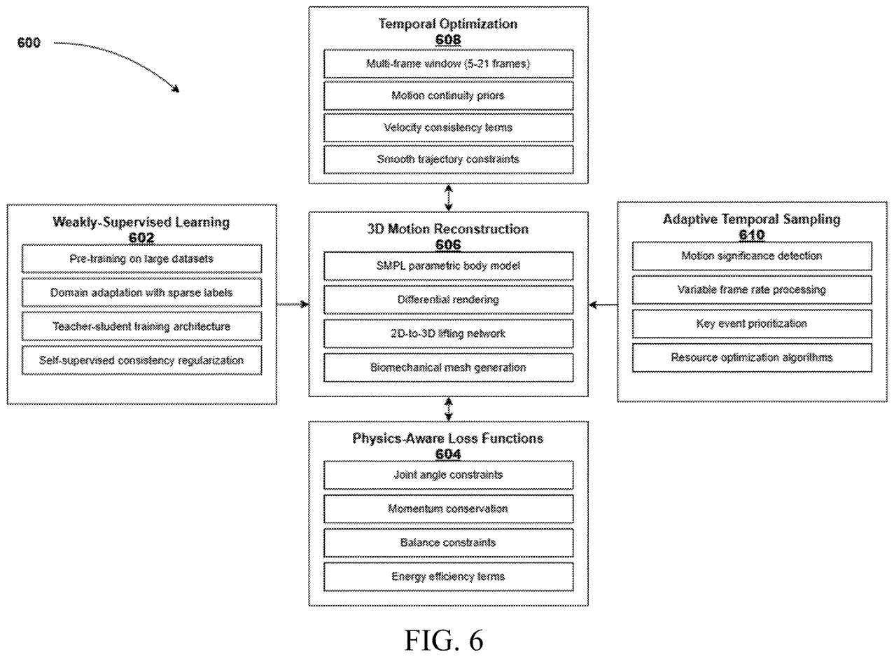

Referring to FIG. 6, a system 600 showing technology modules supporting 3D motion reconstruction is illustrated. System 600 may include a plurality of interconnected modules that cooperate to perform three-dimensional reconstruction of human biomechanical motion from monocular video input. The modules of system 600 may be implemented as software components executed by a processor, as hardware components, or as combinations of software and hardware components.

A 3D motion reconstruction module 606 may be positioned at the center of system 600. 3D motion reconstruction module 606 may contain the parametric body model that represents the human body as a parameterized mesh, as described previously with respect to the three-dimensional reconstruction processing. 3D motion reconstruction module 606 may further contain differential rendering capabilities that enable gradient-based optimization of the body model parameters by computing derivatives of the rendered output with respect to the model parameters. 3D motion reconstruction module 606 may also contain a 2D-to-3D lifting network that converts the two-dimensional anatomical keypoints identified in each frame into three-dimensional joint positions. 3D motion reconstruction module 606 may additionally contain biomechanical mesh generation functionality that produces the three-dimensional human body model and the wire frame model for visualization and analysis.

With continued reference to FIG. 6, a weakly-supervised learning module 602 may feed into 3D motion reconstruction module 606 via a unidirectional connection. Weakly-supervised learning module 602 may enable effective adaptation to new contexts with minimal domain-specific training data. Weakly-supervised learning module 602 may include pre-training on large datasets to establish baseline pose estimation capabilities before adaptation to specific domains. Weakly-supervised learning module 602 may further include domain adaptation with sparse labels that enables the system to learn from partially labeled or unlabeled video data in the target domain.

Weakly-supervised learning module 602 may use a two-stage training methodology with teacher-student training architecture. In the teacher-student training architecture, a teacher model trained on labeled data may generate pseudo-labels for unlabeled data, and a student model may learn from both the labeled data and the pseudo-labeled data. The two-stage training methodology may first train the teacher model on available labeled data and then train the student model using the combined supervision. Weakly-supervised learning module 602 may use self-supervised consistency regularization for domain adaptation. The self-supervised consistency regularization may enforce that the model produces consistent predictions for augmented versions of the same input, enabling learning from unlabeled data without requiring ground truth annotations.

An adaptive temporal sampling module 610 may feed into 3D motion reconstruction module 606 via a unidirectional connection. Adaptive temporal sampling module 610 may include motion significance detection that identifies periods of significant motion within the video sequence. Adaptive temporal sampling module 610 may dynamically adjust processing density based on motion significance detection, allocating more computational resources to periods of high motion significance and fewer resources to periods of low motion significance.

Adaptive temporal sampling module 610 may use variable frame rate processing with key event prioritization. The variable frame rate processing may process frames at different rates depending on the detected motion content, with higher processing rates during periods containing detected events and lower processing rates during periods of minimal motion. The key event prioritization may identify frames containing events of interest and ensure that these frames receive full processing attention. Adaptive temporal sampling module 610 may further include resource optimization algorithms that manage computational resource allocation across the video sequence to achieve efficient processing without degradation in accuracy for significant motion segments.

As further shown in FIG. 6, a temporal optimization module 608 may connect bidirectionally to 3D motion reconstruction module 606. The bidirectional connection may enable temporal optimization module 608 to receive pose estimates from 3D motion reconstruction module 606 and provide temporally refined pose parameters back to 3D motion reconstruction module 606. Temporal optimization module 608 may perform temporal optimization of pose parameters across a plurality of frames simultaneously using motion continuity priors that enforce realistic motion continuity. The temporal optimization may use a multi-frame window for simultaneous optimization. In some cases, the multi-frame window may include 5-21 frames depending on the motion characteristics and computational constraints.

Temporal optimization module 608 may include velocity consistency terms for smooth trajectory constraints. The velocity consistency terms may penalize abrupt changes in joint velocities between consecutive frames, encouraging reconstructions where joint movements follow smooth trajectories over time. The smooth trajectory constraints may improve reconstruction stability by leveraging the physical principle that human motion exhibits continuous velocity profiles rather than instantaneous velocity changes.

A physics-aware loss functions module 604 may connect bidirectionally to 3D motion reconstruction module 606. The bidirectional connection may enable physics-aware loss functions module 604 to evaluate the physical plausibility of pose estimates from 3D motion reconstruction module 606 and provide constraint-based feedback to guide the reconstruction optimization. Physics-aware loss functions module 604 may include joint angle constraints that prevent joints from exceeding their anatomical range of motion, as described previously with respect to the physics-based constraints in the reconstruction optimization.

Physics-aware loss functions module 604 may include momentum conservation terms that encourage physically realistic acceleration patterns. The momentum conservation terms may penalize reconstructions where the implied forces required to produce the observed accelerations exceed physically plausible limits for human movement. Physics-aware loss functions module 604 may further include balance constraints that penalize reconstructions where the body center of mass is not appropriately supported by ground contact points. Physics-aware loss functions module 604 may also include energy efficiency terms that favor reconstructions where the implied muscular effort is consistent with efficient human movement patterns. The energy efficiency terms may penalize reconstructions that would require excessive energy expenditure compared to typical human movement strategies.

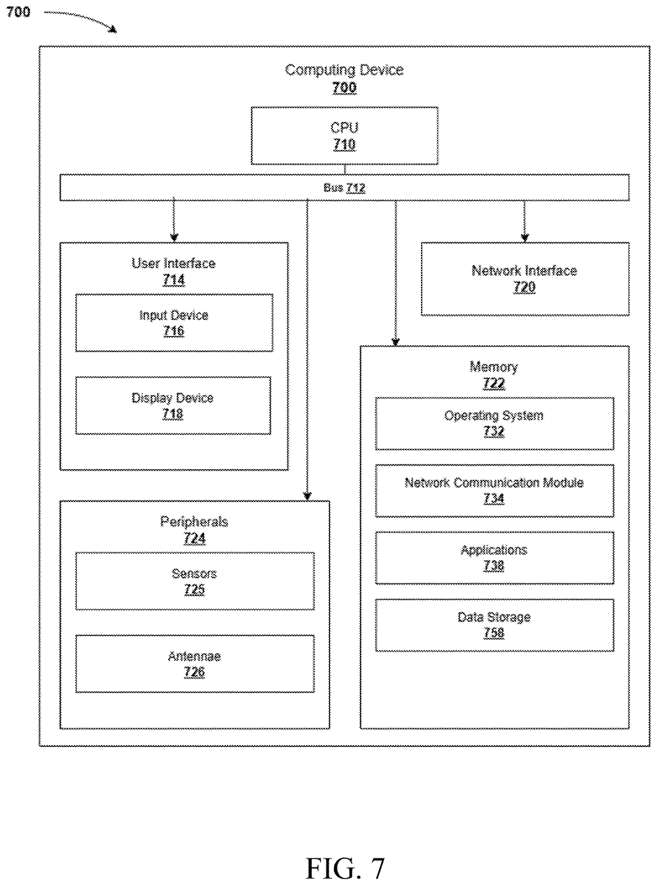

Referring to FIG. 7, a computing device 700 is illustrated. Computing device 700 may be used to implement the systems and methods described herein, including method 100 for hybrid analysis with selective 3D reconstruction, method 400 for handling occlusions during biomechanical motion tracking, and system 600 for 3D motion reconstruction. Computing device 700 may receive video input, perform two-dimensional and three-dimensional analysis operations, and generate biomechanical metrics from reconstructed motion models.

Computing device 700 may include a CPU 710 connected to a bus 712. CPU 710 may execute instructions stored in memory to perform the processing operations described herein, including the lightweight two-dimensional analysis, event detection, three-dimensional reconstruction processing, and occlusion handling operations. Bus 712 may provide a central communication pathway that enables data transfer between CPU 710 and other components of computing device 700. Bus 712 may support various bus protocols and data transfer rates depending on the implementation requirements.

With continued reference to FIG. 7, bus 712 connects to a user interface 714, a network interface 720, peripherals 724, and a memory 722. The connections between bus 712 and these components may enable CPU 710 to communicate with each component for data input, output, storage, and external communication operations.

User interface 714 may contain an input device 716 and a display device 718. Input device 716 may include devices such as keyboards, mice, touchscreens, or other input mechanisms that enable a user to interact with computing device 700. Input device 716 may receive user commands for initiating video analysis, configuring analysis parameters, or selecting video files for processing. Display device 718 may include monitors, screens, or other visual output devices that present information to the user. Display device 718 may display the wire frame model overlaid on the original video, biomechanical metrics, and other analysis results generated by the systems and methods described herein.

Memory 722 may contain an operating system 732, a network communication module 734, applications 738, and data storage 758. Operating system 732 may manage hardware resources of computing device 700 and provide services for applications 738. Network communication module 734 may enable computing device 700 to communicate with external devices and servers over network connections. Applications 738 may include software implementations of the systems and methods described herein, including the hybrid analysis pipeline, occlusion handling system, and 3D motion reconstruction modules. Data storage 758 may store video data, processed motion models, biomechanical metrics, and other data generated or used by the systems and methods described herein.

As further shown in FIG. 7, peripherals 724 may include sensors 725 and antennae 726. Sensors 725 may include cameras for capturing video input, accelerometers, gyroscopes, or other sensing devices that may provide additional data for motion analysis. Antennae 726 may enable wireless communication capabilities for computing device 700, supporting wireless data transfer and network connectivity.

Network interface 720 may enable computing device 700 to connect to local area networks, wide area networks, or the internet for data transfer and communication with external systems. Network interface 720 may support wired connections such as Ethernet or wireless connections through antennae 726. Network interface 720 may enable computing device 700 to interface with external analysis platforms through standardized data transformation protocols.

The systems and methods described herein may be implemented using various hardware technologies. In some cases, the system may be implemented using programmable logic devices including field programmable gate arrays (FPGAs) and programmable array logic (PAL) devices. FPGAs may provide reconfigurable hardware that can be programmed to implement the processing pipelines described herein, enabling hardware acceleration of computationally intensive operations such as the three-dimensional reconstruction processing. PAL devices may provide programmable logic functionality for implementing control logic and data routing operations.

In some cases, the system may be implemented using Graphics Processing Units (GPUs) for software-based circuit emulation. GPUs may provide parallel processing capabilities that accelerate the neural network computations used in the object detection models, vision transformer models, and other machine learning components described herein. The parallel architecture of GPUs may enable efficient processing of the multi-scale Gaussian pyramidal processing, convolutional neural network operations, and transformer attention computations.

In some embodiments, the system may employ a pipelined graphics processing unit architecture for processing video frames. The pipelined architecture may include a first thread that decodes video frames and transfers decoded frame data to graphics processing unit memory. A second thread may perform neural network inference operations on the graphics processing unit including detection, tracking, and three-dimensional body estimation. A third thread may transfer inference results from graphics processing unit memory to system memory.

The threads may communicate through bounded producer-consumer queues that decouple the throughput of each processing stage. The second thread may sequentially apply multiple neural network models on a single graphics processing unit context without context switching between models, reducing overhead associated with allocating and deallocating graphics processing unit resources. The first thread may batch decoded frames into groups of a predetermined size for efficient transfer to graphics processing unit memory.

In some embodiments, the system may process a plurality of videos in batch mode with fault-tolerant resume capability. Each video may be processed in a separate operating system process that isolates graphics processing unit memory allocation, preventing memory leaks from accumulating across videos. A processing manifest stored as a persistent data structure may record a completion status for each video, enabling processing to resume after interruption without reprocessing already-completed work.

In some cases, the system may be implemented using microcontrollers with memory such as erasable programmable read-only memory (EPROM). Microcontrollers may provide embedded processing capabilities for portable or resource-constrained implementations of the systems and methods described herein. EPROM may store firmware and configuration data that define the processing operations performed by the microcontroller.

In some cases, the system may be implemented using metal-oxide semiconductor field-effect transistor (MOSFET) technologies including complementary metal-oxide semiconductor (CMOS). CMOS technology may provide low power consumption and high integration density for implementing the processing components of computing device 400. In some cases, the system may be implemented using bipolar technologies including emitter-coupled logic (ECL). ECL may provide high-speed switching characteristics for applications requiring rapid signal processing. The underlying device technologies may be selected based on performance requirements, power constraints, and integration considerations for the target application.

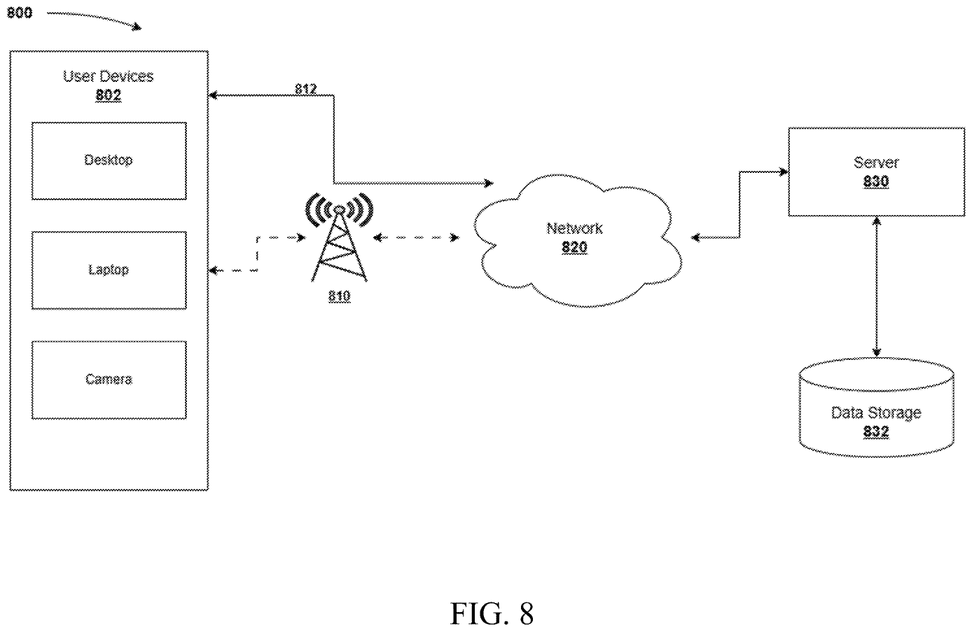

Referring to FIG. 8, a system 800 for distributed biomechanical motion processing and analysis is illustrated. System 800 may enable distributed processing where video capture occurs on lightweight devices while computationally intensive analysis is performed on remote computational resources. System 800 may provide a networked architecture that separates the video acquisition functions from the three-dimensional reconstruction and biomechanical analysis functions, enabling users to capture video using portable devices while leveraging more powerful computational resources for processing.

System 800 includes user devices 802. User devices 802 may include a desktop computer, a laptop computer, and a camera for capturing video input. The desktop computer may provide a workstation for viewing analysis results and interacting with the biomechanical analysis software. The laptop computer may provide portable access to the system for users who require mobility, such as coaches or clinicians working in field settings. The camera may capture the sequence of two-dimensional RGB frames that serve as input for the three-dimensional motion reconstruction processing described with respect to method 100 and system 600. User devices 802 may run lightweight software components that handle video capture, user interface functions, and communication with backend processing components, while offloading computationally intensive operations to remote servers.

With continued reference to FIG. 8, user devices 802 communicate with a network 820 via a wireless connection 810 and a wired connection 812. Wireless connection 810 may be represented by a radio tower providing wireless connectivity. Wireless connection 810 may enable user devices 802 to connect to network 820 without physical cable connections, supporting mobile use cases where wired infrastructure is unavailable. Wireless connection 810 may use wireless communication protocols such as Wi-Fi, cellular data networks, or other wireless technologies depending on the deployment environment and bandwidth requirements.

Wired connection 812 may provide direct network access for user devices 802. Wired connection 812 may offer higher bandwidth and lower latency compared to wireless connection 810, which may be advantageous when transferring large video files or when real-time analysis feedback is desired. User devices 802 may connect to network 820 via wired connection 812 using Ethernet or other wired networking technologies. The choice between wireless connection 810 and wired connection 812 may depend on the deployment environment, available infrastructure, and performance requirements for the specific use case.

Network 820 may include cloud-based network infrastructure that routes data between user devices 802 and backend components. Network 820 may include routers, switches, and other networking equipment that direct data packets between source and destination devices. Network 820 may span local area networks, wide area networks, and internet infrastructure depending on the geographic distribution of user devices 802 and backend components. The cloud-based architecture of network 820 may provide scalability, enabling the system to accommodate varying numbers of concurrent users and processing demands.

As further shown in FIG. 8, a server 830 connects to network 820. Server 830 may provide computational resources for performing three-dimensional motion reconstruction and biomechanical analysis. Server 830 may execute the processing operations described with respect to method 100, method 400, and system 600, including the lightweight two-dimensional analysis, event detection, three-dimensional reconstruction processing, occlusion handling, and biomechanical metrics generation. Server 830 may include processors, GPUs, and memory resources configured to handle the computational demands of the neural network models, parametric body model optimization, and temporal optimization procedures.

Server 830 may receive video data from user devices 802 via network 820, process the video data to generate three-dimensional motion models and biomechanical metrics, and transmit the analysis results back to user devices 802 for display and user interaction. The distributed architecture may enable user devices 802 to be lightweight devices with limited computational capabilities, as the intensive processing operations are performed on server 830 rather than on user devices 802.

A data storage 832 may connect to server 830. Data storage 832 may store video data received from user devices 802, processed motion models generated by the three-dimensional reconstruction processing, and analysis results including biomechanical metrics. Data storage 832 may provide persistent storage that enables retrieval of historical analysis results for comparison, longitudinal tracking, and archival purposes. Data storage 832 may use database systems, file storage systems, or other storage technologies depending on the data volume and access pattern requirements.

System 800 may interface with external analysis platforms through standardized data transformation protocols for biomechanical integration. The standardized data transformation protocols may convert the three-dimensional motion models and biomechanical metrics generated by system 800 into formats compatible with external biomechanical analysis software. The standardized formats may include motion capture file formats, joint angle representations, and other data structures used by biomechanical analysis tools. The interface capability may enable users to leverage specialized analysis software for domain-specific applications while using system 800 for the motion capture and reconstruction functions.

System 800 may be capable of processing arbitrarily long video sequences without degradation in performance or accuracy for unlimited-length video analysis. The unlimited-length processing capability may be achieved through streaming processing architectures that process video frames incrementally rather than loading entire video sequences into memory simultaneously. Server 830 may process video frames in batches or as continuous streams, maintaining tracking state and temporal context across batch boundaries to ensure consistent analysis quality regardless of video duration. Data storage 832 may store intermediate processing results and tracking state information to support resumption of processing after interruptions and to enable analysis of video sequences that exceed the memory capacity of server 830.

System 800 may include sport-specific algorithm modifications for robust object tracking in challenging sporting scenarios. The sport-specific algorithm modifications may adapt the object detection models, pose estimation models, and tracking algorithms to the characteristics of particular sports. Different sports may present different tracking challenges, including varying numbers of subjects, different typical poses and movements, different equipment and environmental conditions, and different occlusion patterns. The sport-specific modifications may include trained model variants optimized for particular sports, sport-specific motion priors for the predictive trajectory estimation described with respect to method 400, and sport-specific event detection classifiers for the event detection described with respect to method 100. The sport-specific algorithm modifications may improve tracking accuracy and robustness in challenging sporting scenarios where generic algorithms may struggle due to fast motion, frequent occlusions, or unusual body configurations.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth. The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

1-20. (canceled)

21. A method for generating a three-dimensional body reconstruction from monocular video, comprising:
receiving, by one or more processors, a sequence of image frames depicting a human subject captured by a single camera;
extracting, by the one or more processors, image features from the sequence of image frames;
processing the image features through a first neural network model to regress three-dimensional body mesh vertices;
processing the image features through a second neural network model, distinct from the first neural network model, to produce body pose parameters in a camera-space reference frame;
geometrically aligning, by the one or more processors, outputs of the first neural network model and the second neural network model using a rigid transformation to produce an aligned three-dimensional body reconstruction; and
generating at least one biomechanical metric from the aligned three-dimensional body reconstruction.

22. The method of claim 21, wherein the rigid transformation comprises a Procrustes analysis that computes a rotation, a translation, and optionally a scale transformation that minimizes positional error between corresponding points of the outputs of the first neural network model and the second neural network model.

23. The method of claim 21, further comprising applying segment-specific temporal filtering to the aligned three-dimensional body reconstruction, wherein torso parameters are filtered at a first cutoff frequency and extremity parameters are filtered at a second, different cutoff frequency.

24. The method of claim 23, wherein the segment-specific temporal filtering employs zero-phase filtering applied in both forward and reverse directions.

25. The method of claim 21, further comprising deriving virtual anatomical markers from mesh vertices of the aligned three-dimensional body reconstruction using a learned joint regressor matrix that maps vertex positions to anatomical joint locations.

26. The method of claim 25, further comprising fitting a musculoskeletal skeleton model to the virtual anatomical markers using an inverse kinematics solver to compute joint-angle time series.

27. The method of claim 21, further comprising estimating a ground plane from the aligned three-dimensional body reconstruction based on foot contact positions and normalizing the reconstruction to a canonical coordinate system defined relative to the estimated ground plane.

28. A system for generating a three-dimensional body reconstruction from monocular video, comprising:
a non-transitory memory storing instructions; and
one or more processors coupled to the non-transitory memory and configured to execute the instructions to:
receive a sequence of image frames depicting a human subject captured by a single camera;
extract image features from the sequence of image frames;
process the image features through a first neural network model to regress three-dimensional body mesh vertices;
process the image features through a second neural network model, distinct from the first neural network model, to produce body pose parameters in a camera-space reference frame;
geometrically align outputs of the first neural network model and the second neural network model using a rigid transformation to produce an aligned three-dimensional body reconstruction; and
generate at least one biomechanical metric from the aligned three-dimensional body reconstruction.

29. The system of claim 28, wherein the rigid transformation comprises a Procrustes analysis that computes a rotation, a translation, and optionally a scale transformation that minimizes positional error between corresponding points of the outputs of the first neural network model and the second neural network model.

30. The system of claim 28, wherein the one or more processors are further configured to apply segment-specific temporal filtering to the aligned three-dimensional body reconstruction, wherein torso parameters are filtered at a first cutoff frequency and extremity parameters are filtered at a second, different cutoff frequency.

31. The system of claim 30, wherein the segment-specific temporal filtering employs zero-phase filtering applied in both forward and reverse directions.

32. The system of claim 28, wherein the one or more processors are further configured to derive virtual anatomical markers from mesh vertices of the aligned three-dimensional body reconstruction using a learned joint regressor matrix that maps vertex positions to anatomical joint locations.

33. The system of claim 32, wherein the one or more processors are further configured to fit a musculoskeletal skeleton model to the virtual anatomical markers using an inverse kinematics solver to compute joint-angle time series.

34. The system of claim 28, wherein the one or more processors are further configured to estimate a ground plane from the aligned three-dimensional body reconstruction based on foot contact positions and normalize the reconstruction to a canonical coordinate system defined relative to the estimated ground plane.

35. A non-transitory computer-readable medium storing instructions that, when executed by one or more processors, cause the one or more processors to perform operations comprising:
receiving a sequence of image frames depicting a human subject captured by a single camera;
extracting image features from the sequence of image frames;
processing the image features through a first neural network model to regress three-dimensional body mesh vertices;
processing the image features through a second neural network model, distinct from the first neural network model, to produce body pose parameters in a camera-space reference frame;
geometrically aligning outputs of the first neural network model and the second neural network model using a rigid transformation to produce an aligned three-dimensional body reconstruction; and
generating at least one biomechanical metric from the aligned three-dimensional body reconstruction.

36. The non-transitory computer-readable medium of claim 35, wherein the rigid transformation comprises a Procrustes analysis that computes a rotation, a translation, and optionally a scale transformation that minimizes positional error between corresponding points of the outputs of the first neural network model and the second neural network model.

37. The non-transitory computer-readable medium of claim 35, wherein the operations further comprise applying segment-specific temporal filtering to the aligned three-dimensional body reconstruction, wherein torso parameters are filtered at a first cutoff frequency and extremity parameters are filtered at a second, different cutoff frequency.

38. The non-transitory computer-readable medium of claim 37, wherein the segment-specific temporal filtering employs zero-phase filtering applied in both forward and reverse directions.

39. The non-transitory computer-readable medium of claim 35, wherein the operations further comprise deriving virtual anatomical markers from mesh vertices of the aligned three-dimensional body reconstruction using a learned joint regressor matrix that maps vertex positions to anatomical joint locations.

40. The non-transitory computer-readable medium of claim 39, wherein the operations further comprise fitting a musculoskeletal skeleton model to the virtual anatomical markers using an inverse kinematics solver to compute joint-angle time series.
